(19) United States
(12) Patent Application Publication
(10) Pub. No.: US 2026/0340547 A1
(43) Pub. Date: Oct. 29, 2026

(54) ENTERPRISE RISK MANAGEMENT AND PROTECTION

(71) Applicant: Sontig, Inc., Nottingham, MD (US)

(72) Inventors: Alphonse Roland PASCUAL, III, Benicia, CA (US); Kyle Andrew MARCHINI, Nottingham, MD (US); James E. VAN DYKE, Pleasanton, CA (US)

(21) Appl. No.: 19/101,523

(22) PCT Filed: Aug. 4, 2023
(86) PCT No.: PCT/US2023/071695

§ 371 Date: Feb. 5, 2025

Related U.S. Application Data
(60) Provisional application No. 63/395,573, filed on Aug. 5, 2022.
(60) Provisional application No. 63/417,525, filed on Oct. 19, 2022.

(51) Int. Cl. G06Q 10/0635; G06F 21/62

(52) U.S. Cl. CPC G06Q 10/0635; G06F 21/6218

(57) ABSTRACT

A system and method for providing a holistic view of security and financial risks posed to an enterprise as a result of data exposures and/or breaches of employees, vendors, or other members of its workforce, such as with an enterprise risk protection interface configured to visually provide a holistic view of security and financial risks posed to the enterprise as a result of the compromised credentials.

WO

### INTRODUCTION

The present disclosure relates to systems and methods for risk management protection, such as but not limited to systems and methods capable of providing a holistic view of security and financial risks posed to an enterprise as a result of data exposures and/or breaches of employees and vendors.

Stolen identity information of employees and vendors can create gaps in an organization's cybersecurity posture. Their compromised personally identifiable information (PII) can open the door to threats, such as business email compromise, unauthorized use of company cards, phishing attacks, and fraudulent payment scams. One non-limiting aspect of the present disclosure contemplates a need for an enterprise or other organization to measure and monitor the security and financial risks posed by an enterprise team member's compromised data. Cybercrime makes headlines every day, and among the avenues that cybercriminals leverage for gaining access to an organization's data and finances, it is people that tend to be the most targeted. According to some studies, 85% of data breaches can be traced back to the human attack surface (i.e., the compromise of company and/or vendor employees). Traditional solutions leave blind spots for enterprises looking to understand the accumulated risk exposure created by employees, vendors, and other others in the employ thereof. Small-and medium-sized businesses are especially at risk, with over 70% of all ransomware attacks affecting organizations with fewer than 1000 employees, according to some studies.

### SUMMARY

One non-limiting aspect of the present disclosure relates to providing a holistic view of security and financial risks posed to an enterprise as a result of data exposures and/or breaches of employees, vendors, or other members of its workforce, such as with an enterprise risk protection interface configured to visually provide a holistic view of security and financial risks posed to the enterprise as a result of the compromised credentials.

One non-limiting aspect of the present disclosure relates to a system and method for enterprise risk management and protection including and/or configured for: receiving a plurality of monitored credentials for employees and vendors working for an enterprise, the monitored credentials being susceptible to exposure in the event of the employee or vendor associated therewith being compromised; receiving a plurality of breach records for a plurality of data breaches, each breach record representing breached data exposed as a result of the data breach associated therewith; comparing the breachable data to the breached data to identify one or more compromised credentials, the compromised credentials representing the monitored credentials exposed as a result of the data breaches; and generating a dashboard to visually provide a holistic view of security and financial risks posed to the enterprise as a result of the compromised credentials, the dashboard being electronically displayable through a user interface.

One non-limiting aspect of the present disclosure relates to an electronic device having at least one processor, a memory communicatively coupled to the at least one processor, and the memory that stores instructions executable by the at least one processor to perform the method for enterprise risk management and protection.

One non-limiting aspect of the present disclosure relates to a non-transitory computer readable storage medium storing computer instructions to enable a computer to perform the method for enterprise risk management and protection.

One non-limiting aspect of the present disclosure relates to a computer program product executed by a processor to perform the method for enterprise risk management and protection as described herein.

The above features and advantages along with other features and advantages of the present teachings are readily apparent from the following detailed description of the modes for carrying out the present teachings when taken in connection with the accompanying drawings. It should be understood that even though the following Figures and embodiments may be separately described, single features thereof may be combined to additional embodiments.

### BRIEF DESCRIPTION OF THE DRAWINGS

The accompanying drawings, which are incorporated into and constitute a part of this specification, illustrate implementations of the disclosure and together with the description, serve to explain the principles of the disclosure.

FIG. 1 is a schematic illustration of an enterprise risk management and protection system in accordance with one non-limiting aspect of the present disclosure.

FIG. 2 illustrates selection of a dashboard menu from the enterprise risk protection interface in accordance with one non-limiting aspect of the present disclosure.

FIG. 3 illustrates a flowchart of a risk management and protection method for generating the holistic view of security and financial risks in accordance with one non-limiting aspect of the present disclosure.

FIG. 4 illustrates a vendor subjects menu in accordance with one non-limiting aspect of the present disclosure.

FIG. 5 illustrates an enter vendor details page in accordance with one non-limiting aspect of the present disclosure.

FIG. 6 illustrates an employee subjects menu in accordance with one non-limiting aspect of the present disclosure.

FIG. 7 illustrates an enter employee details page in accordance with one non-limiting aspect of the present disclosure.

FIG. 8 illustrates a data theft or tampering impact explanation page in accordance with one non-limiting aspect of the present disclosure.

FIG. 9 illustrates a breach explanation page in accordance with one-limiting aspect of the present disclosure.

FIG. 10 illustrates an activate two-factor authentication recommendation explanation page in accordance with one non-limiting aspect of the present disclosure.

FIG. 11 illustrates the cumulative risk scores associated with sorting the subjects callout according to the employees category in accordance with one non-limiting aspect of the present disclosure.

FIG. 12 illustrates the cumulative risk scores associated with sorting the subjects callout according to the vendors category in accordance with one non-limiting aspect of the present disclosure.

FIG. 13 illustrates the reports menu in accordance with one non-limiting aspect of the present disclosure.

FIG. 14 illustrates a report generation page in accordance with one non-limiting aspect of the present disclosure.

FIG. 15 illustrates a business subjects menu in accordance with one non-limiting aspect of the present disclosure.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

The term “enterprise” as used herein is not to be limiting, and is to be construed broadly to comprise businesses, companies, corporate-controlled groups, associations, partnerships, government agencies, non-profits, or other legal formations relying upon others to perform work and otherwise engage in other related activities. The terms “employee”, “vendor”, “team member”, and the like are used herein, and interchangeably, and are not to be limiting but instead construed broadly to refer to persons, other enterprises, contractors, individuals, suppliers, providers, manufacturers, sellers, etc. working in the employ, at the behest of, or otherwise conducting an undertaking for an enterprise, e.g., any person or entity relied upon by the enterprise to provide a service, with or without any corresponding remuneration, which may be collectively and generically referred to herein in a non-limiting manner with the term “workforce”.

The term “data breach” as used herein is not to be limiting, and is to be construed broadly to comprise any incident in which data has been exposed in a manner that creates a possibility or potential for harm, hurt, loss and/or injury to the data owner, including, for example, identity theft, financial loss, loss of privacy, extortion, etc. A data breach, as that term is used herein, may also be referred to, and/or comprise, one or more of a data theft, data compromise, unauthorized data access, unauthorized data exposure, a data hack, a data intrusion, a data penetration, physical lost or stolen personally identifiable information, etc. A data breach may also be referred to herein as a “data compromise” and/or as a “breach event.”

The term “breachable data” as used herein is not to be limiting, and is to be construed broadly to comprise information elements and other data constructs, files, values, datums, etc. that can be breached and/or compromised, and can include one or more of personally identifiable information (PII), protected health information (PHI), payment card industry (PCI) data, and other such information which can, if breached and/or compromised, expose the breached victim and/or their employer to risk, injury, and/or harm. The breachable data, as that term is used herein, may comprise any type of data associated with an employee, a vendor, a team member, or other in the employ of an enterprise, which, if compromised, could cause harm to the enterprise.

The term “breached data” as used herein is not to be limiting, and is to be construed broadly to comprise information elements and other data constructs, or more specifically the breachable data, which has been exposed, compromised, revealed, targeted, captured, or otherwise divulged directly or indirectly by a bad or nefarious actor as result of a data breach of the source associated therewith, i.e., as result of the employee, vendor, team member, etc., either directly or indirectly, being compromised by the data breach. The breached data may comprise all or a portion of the breachable data threatened as a consequence of a corresponding data breach.

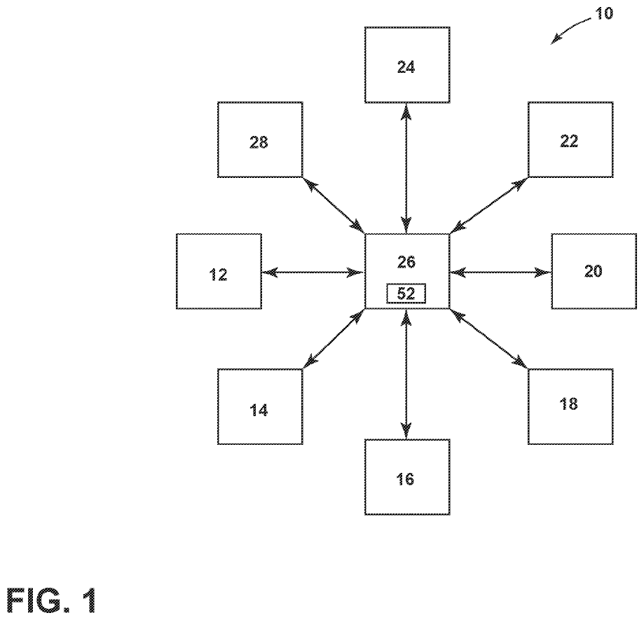

FIG. 1 is a schematic illustration of an enterprise risk management and protection system 10 in accordance with one non-limiting aspect of the present disclosure. The enterprise risk management protection system 10, which is predominately referred to herein as the enterprise system 10, may include and use a plurality of data structures 12, tabulation formats 14, quantitative and qualitative research 16, algorithms 18, reporting services 20 that in combination compute risk-related outputs 22 designed to manage risk for an enterprise 24. The results 22 can be outputted to an operator 28 or other manager of the enterprise via a user interface (UI) of a computer or other user device, such as through an enterprise risk protection interface 26 and/or to a sponsoring entity or institution, such as a banking institution or other financial services provider, health services provider, or other resource provider engaged in providing a service or product to enterprises, via one or more institution UIs. The cumulative data structures, tabulation formats, quantitative and qualitative research, and algorithms that may be used in combination to compute risk-related outputs, perform fraud analysis, generate aggregated enterprise breach histories and to analyze, accumulate, and report data breach events may be referred to herein as BreachIQ™ Monitor.

One aspect of the present disclosure contemplates the enterprise system 10 being configured to provide a holistic view of security and financial risks posed to the enterprise as a result of exposure caused by data breaches to its employees, vendors, etc., which for the sake of simplicity of presentation are collectively and predominately referred to as the workforce. As described below in more detail, the enterprise system 10 may be configured to generate performance metrics, values, rankings, scores, etc., which may be packaged for use individually and/or cooperatively to provide, in accordance with one non-limiting aspect of the present disclosure, the enterprise risk protection interface 26 operable to visually provide a holistic view of security and financial risks posed to the enterprise as a result of the compromised credentials of its workforce. While any number of mechanisms may be suitable to facilitate providing this holistic view of enterprise risk management and protection, the enterprise risk protection interface may be computer generated for electronic display through the enterprise risk protection interface 26, optionally to engage with an operator 28 of the enterprise 24, such as in the form of webpage, portal, data feed, control panel, or other instrument capable of providing an at-a-glance view of enterprise risk management and protection related information, optionally with capabilities to navigate through or otherwise interact with the presented information.

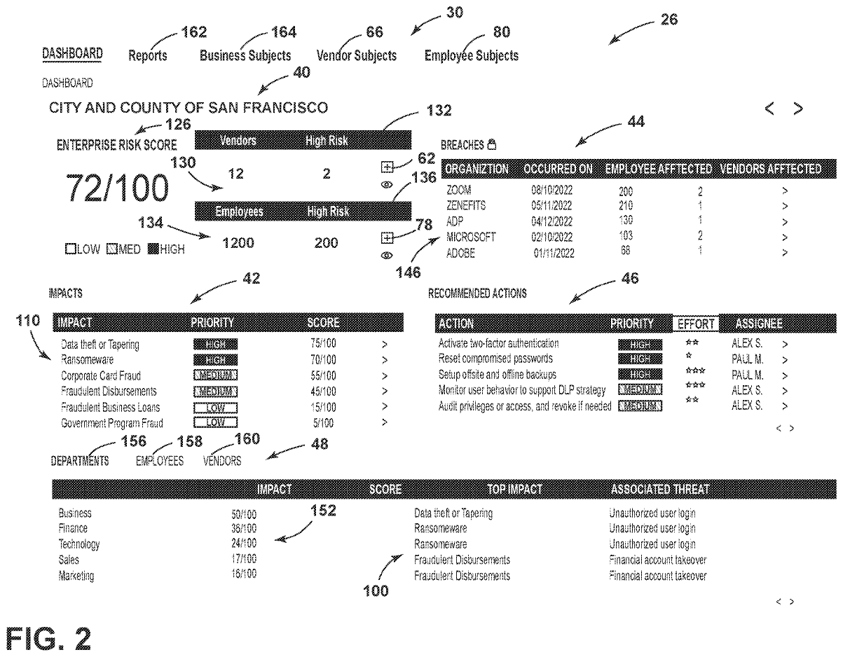

FIG. 2 illustrates selection of a dashboard menu 30 from the enterprise risk protection interface 26 in accordance with one non-limiting aspect of the present disclosure. The dashboard menu 30 may include a plurality callouts or feeds 40, 42, 44, 46, 48 electronically generated in the manner described herein to provide a visual assemblage of threat and risk related information useful in assessing security and financial risk, and therethrough enable the enterprise 24 to ameliorate and better interpret the related perils and correspondingly improve enterprise risk management and protection through the accumulation and useful presentation of risk information. While a variety of callouts 40, 42, 44, 46, 48 may be beneficial, one non-limiting aspect of the present disclosure contemplates generating the callouts 40, 42, 44, 46, 48, which may be comprised of corresponding data feeds, information streams, etc., to communicate related information, optionally with the callouts 40, 42, 44, 46, 48 being tailored or changed at the operators 28 behest, such as to adapt the callouts 40, 42, 44, 46, 48 to focus on a particular risk. The illustrated callouts 40, 42, 44, 46, 48 are shown for exemplary purposes as including an accumulated risk callout 40, an impacts callout 42, a breach history callout 44, a recommended actions callout 46, and a selectable subject breach callout 48, which are believed to be collectively beneficial in providing a holistic view of security and financial risk posed to the enterprise 24.

In addition to highlighting threats and risks to the enterprise 24, the dashboard menu 30 may also be configured in accordance with one non-limiting aspect of the present disclosure to facilitate presenting corrective actions and other measures capable of being undertaken, or at least recommended to be taken, in order to combat or mitigate a severity, a continuance, or a consequence of an associated one or more of the threats and risks. The dashboard menu 30, at least in this regard, may provide the contemplated at-a-glance assemblage of threat and risk related information while additionally providing additional callouts 40, 42, 44, 46, 48 for counteracting the influence thereof, which may be similarly beneficial in providing a quick appraisal of the ways the enterprise can protect against risks. The capability of the present disclosure to provide an easy understanding of problems and solutions is believed to be particularly beneficial in providing a tangible medium wherethrough the computations, logic, and other processes described herein may be interfaced with the operator 28. The enterprise risk protection interface 26, accordingly, is believed to be a substantial technological and functional improvement capable of reflecting the underlying computation processes and logical procedures described herein in a manner that the operator 28 would otherwise be unable to replicate and in a manner that renders and transforms the underlying information into a significantly more helpful and beneficial form.

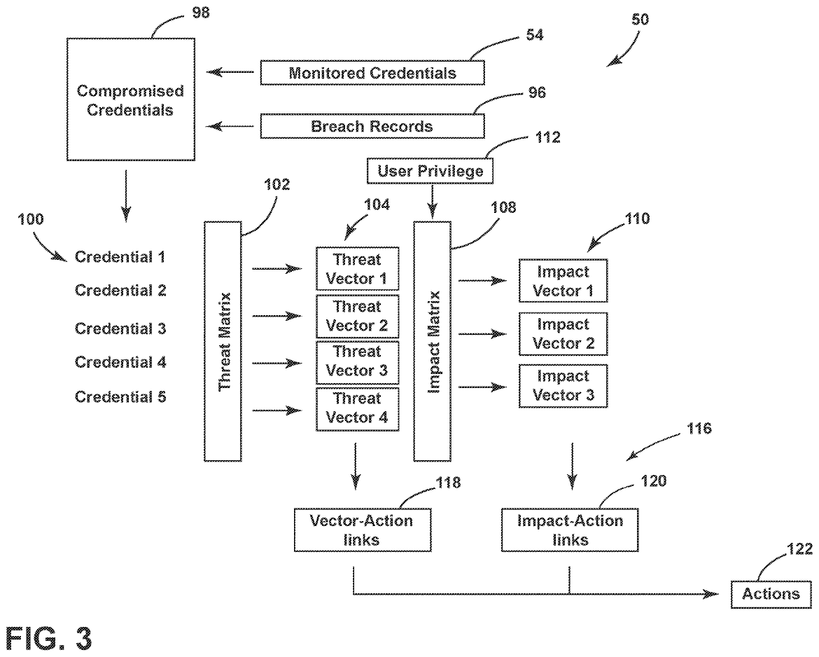

FIG. 3 illustrates a flowchart 50 of a risk management and protection method for generating the holistic view of security and financial risks in accordance with one non-limiting aspect of the present disclosure. The method may be described with respect to a plurality of processes, which may be executed, performed, or otherwise enabled according to execution of corresponding instructions, operations, etc., optionally with one or more of the processes being performed by a corresponding controller, module, etc. As shown in FIG. 1, the enterprise system 10 may include a monitor controller 52 configured to generate and maintain the dashboard menu 30, which may in turn include a separate controller or construct for each of the flowchart processes. The monitor controller 52 may include a processor and a computer-readable storage medium with a plurality of non-transitory instructions stored thereon, which when executed with the processor, are sufficient to facilitate the computation processes and logical procedures described, including those used to render and transform the underlying information into a form suitable for interfacing with the operator 28 through the enterprise risk protection interface 26. One non-limiting aspect of the present disclosure contemplates facilitating the risk management and protection from the enterprise 24 point of view, and particularly as a result of and after the occurrence of data breaches and other security compromises of its workforce. This after-the-fact type of analysis may be contrasted to preventative measures taken before a breach event, such as preventative measures taken to thwart direct attacks and hacks on the enterprise's 24 information technology (IT) infrastructure, servers, email, etc. While the present disclosure fully contemplates the enterprise risk protection interface 26 and the operations described herein being useful in assessing data breaches to the enterprise 24 beforehand, the enterprise risk protection interface 26 is predominately described with respect to reporting and providing insights derived from monitoring outside attacks on its employees that may in turn result in harm to the enterprise 24.

It is well known to one having ordinary skill in the art that one of the larger dangers to an enterprise's 24 security comes from activities of its workforce, and specifically inadvertent or improper disclosures of breachable data by its employees and vendors. The vendors and employees may be individually targeted and compromised, and while the enterprise 24 may take preventative security measures ahead of time in an effort to thwart those attacks, such as by providing firewalls or educating the workforce to avoid scams and other attacks, one non-limiting aspect of the present disclosure contemplates providing the enterprise 24 an ability to assess to the enterprise's harm after the workforce inevitably circumvents the preventative measures and becomes compromised. One non-limiting aspect of the present disclosure, as such, generates the enterprise risk protection interface 26 in an effort to provide the enterprise 24 leverage and protection against an accumulation of risks arising after a data breach has occurred. The enterprise risk protection interface 26, in other words, may be a useful tool in providing feedback to the enterprise 24 so that the enterprise 24 can then use that feedback to identify the compromised employees and/or vendors and to instigate the recommended mitigation and protection actions.

In an effort to ascertain the breachable data and other information at risk of being exposed by the workforce, i.e., the personal and other non-enterprise data of workforce that originates individually with the vendors and employees, as optionally opposed to the corporate or enterprise originating information, the risk management and protection method may include a monitored credentials process 54 whereby the monitor controller 54 receives a plurality of monitored credentials for the employees and vendors of the enterprise 24. The monitored credentials may contain data entries for one or more of a plurality of data types, with the data entries representing breachable data susceptible to exposure in the event of the employee or vendor associated therewith being compromised. The monitored credentials, or more specifically the information and data entries associated therewith, may be identified beforehand to correspond with data expected to be or is commonly subjected to breach, theft, or other compromising activities. The monitored credentials process may correspond with requesting the workforce to provide the monitor controller 52 with information the monitor controller 52 may then monitor relative to data breaches, and based on assessment of relationship therebetween, present a holistic view of security financial risk posed to the enterprise 24. The monitored credentials may be used in this manner to provide a baseline or reference datum for assessing areas of the enterprise 24 potentially subjected to compromise.

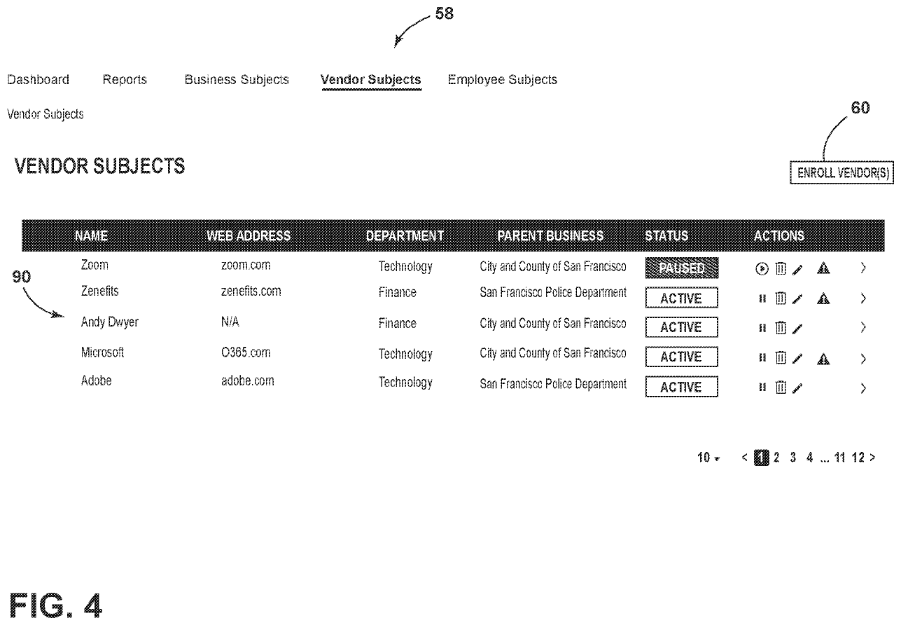

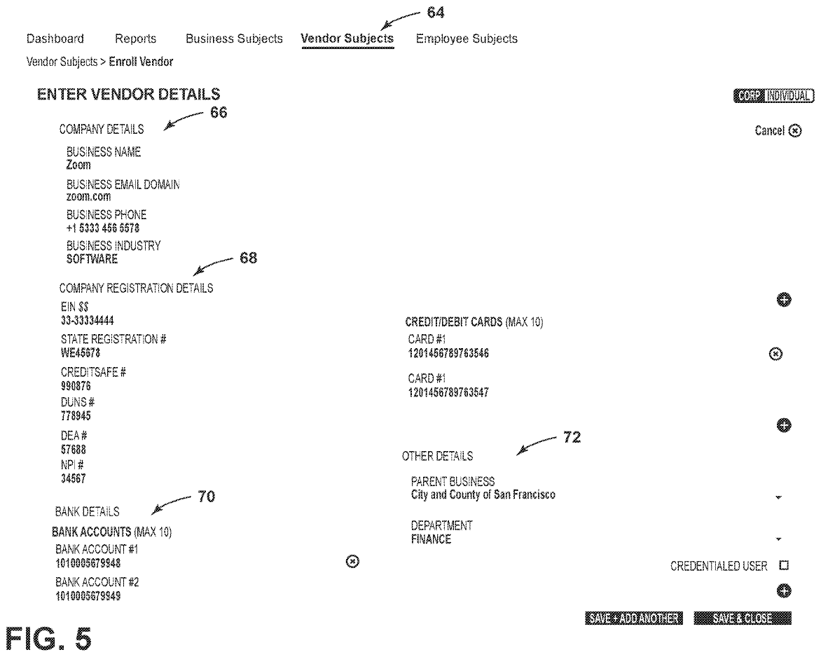

The monitored credentials may be provided by the employees, the vendors, and other members of the workforce, such as through the workforce and/or the operator 28 interacting with the dashboard menu 30 as part of an enrollment processes. FIG. 4 illustrates a vendor subjects menu 58 wherethrough the operator 28 and/or the vendors may click on an enroll vendor button 60 to enter the monitored credentials for the corresponding vendor. The vendor subjects menu 58 may be accessible to the operator 28 by clicking on a vendor add icon 62 or a vendor subjects tab 66 included in the dashboard menu 30 and/or to the vendor through another portal or enrollment feature, e.g., the enterprise risk protection interface 26 may be inaccessible to the vendor such that the vendor may submit the monitored credentials through another access point to the vendor subject page 58. FIG. 5 illustrates an enter vendor details page 64 available for inputting the monitored credentials for one of the vendors in accordance with one non-limiting aspect of the present disclosure. The enter vendor details page 64 is shown for exemplary and non-limiting purposes with respect to an entry form type of configuration whereby data types correspond with a company details section 66, a company registration details section 68, a bank details section 70, and an other details section 72.

The company details section 66 may include data types for a business name, a business email domain, a business phone, a business industry drop-down selection menu. The company registration details section 68 may include data types for an employment identification number (EIN), a state registration number, a credit safe number, a DUNS number, a DEA number, a NPI number. The bank details section 70 may include data types for one bank account numbers and/or one or more credit/debit card numbers. The other details section 72 may include data types for a parent business drop-down menu and a department drop-down menu. Information added into each of the data types 66, 68, 70, 72 may become with the data entries forming the monitored credentials for the vendor, and which may thereby comprise the breachable data for that vendor. In the event more or less information is entered, i.e., in the event the more data types are provided or the vendor otherwise provides more data entries, the breachable data for that vendor may correspondingly vary. The vendor may additionally submit other information through a form entry page, e.g., a bulk upload or other file type of submission, and/or add non-requested information to the monitored credentials that the vendor may be believed to be susceptible to compromise. The monitored credentials process 54 may include a similar sequence for employees.

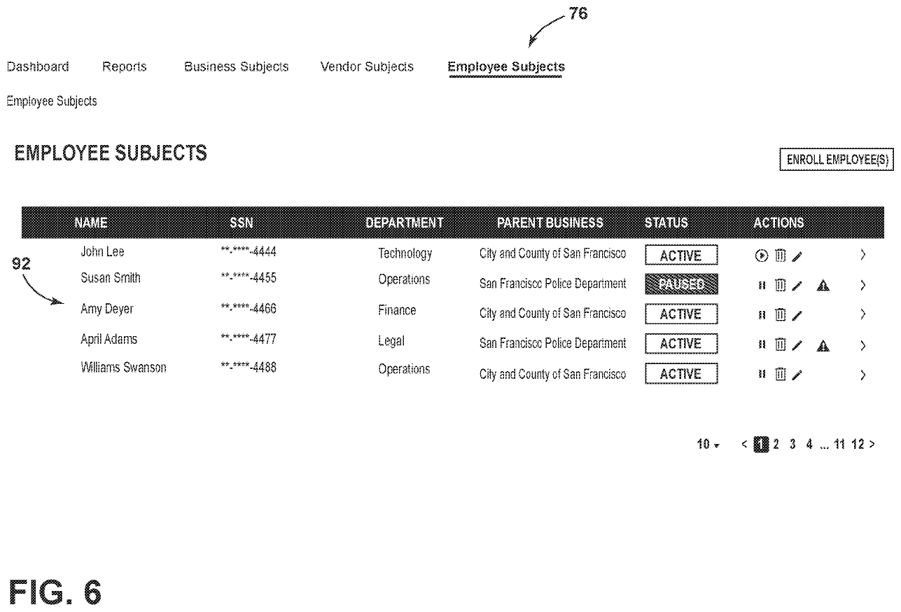

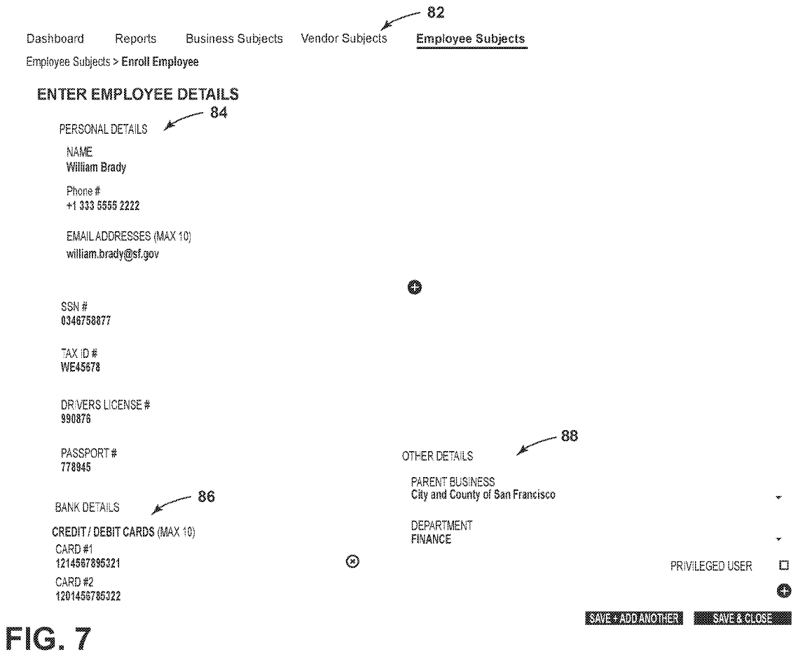

FIG. 6 illustrates an employee subjects menu wherethrough the operator 28 and/or the employees may click on an enroll employee button to enter monitored credentials for the corresponding employee in accordance with one non-limiting aspect of the present disclosure. The employee subjects menu 76 may be accessible to the operator 28 by clicking on an employee eyeball icon 78 or an employee subjects tab 80 included in the dashboard menu 30 and/or by the employee through another portal or enrollment feature, e.g., enterprise risk protection interface 26 may be inaccessible to the employee such that the employee may submit the monitored credentials through another access point. FIG. 7 illustrates an enter employee details page 82 available for inputting the monitored credentials for one of the employees in accordance with one non-limiting aspect of the present disclosure. The enter employee details page 82 is shown for exemplary and non-limiting purposes with respect to an entry form type of configuration whereby the data types correspond with a personal details section 84, a bank details section 86, and an other details section 88. The personal details section or may include data types for a name, a phone number, a Social Security number (SSN), a tax ID number, a driver license number, and a passport number. The bank details section 86 may include data types for credit/debit cards. The other detail section 88 may include parent business drop-down and a department drop-down selection menu.

The vendor subjects menu 58 (FIG. 4) and the employee subjects menu 76 (FIG. 7) may be similar insofar as collecting data entries for the vendors and employees, with the option to include more or less data types and/or data entries. The data entries made through either page 58, 76 may be assimilated on a per employee or a per vendor basis to establish a record or a set of monitored credentials. Each of the pages 58, 76 may include a listing of those registered therewith, i.e., a vendor listing 90 in the vendor subjects menu may include a name, a web address, department, a parent business, a status, and an actions menus for each of the enrolled vendors, and an employee listing 92 of the employee subjects menu may include a name, a SSN, a department, the parent business, a parent business, a status, and an actions menu for each of the enrolled employees. Returning to FIG. 3, the monitor credentials process 54, whether through one of the above described enrollment pages or through other means, may relate to collecting various data entries for different data types, with the resulting data being compiled into monitored credentials capable of being used to identify threats and other potential harms to the enterprise 24.

The risk management and protection method 50 may include a breach of records process 96 for ascertaining breached data or other breach information exposed as a result of a data breach. In an illustrative example, and as described in related International Patent Application Number PCT/US2018/047237 published as WO 2019/040443, the contents of which are incorporated herein by reference, the breach information can include information related to one or more breach events, which can include identifying information identifying employees, vendors, consumers, etc. that have been victimized by one or more breaches. This may include identifying information elements breached in the breach event, the information source from which the breach event was reported, information indicating whether fraud or other harm has been detected from use of the breached information, and the like. In a non-limiting example, the information source from which a breach event can be reported can include a self-reporting entity reporting information related to a breach which has been experienced by the self-reporting entity, which may also be a resource institution. The information source providing the breach information can be a regulatory or government organization or other organization configured to receive and report breach event information, such as the U.S. Federal Trade Commission or a private entity such as the Identity Theft Resource Center (ITRC), as examples of reporting entities described further herein. In one example, an information source of breach information can be a dark web service provider, which may be an entity which is configured to monitor the dark web, also referred to as the Darknet, to detect breach events, breached information, and/or data markets offering stolen, compromised, phished, breached or unauthorized personal information and/or credentials for sale.

The breach records process 96, as such, may correspond with identifying breach records, breach information, and other breach related data from any number of sources, which may include breach events associated with the enterprise 24, which the enterprise 24 may already be aware of, as well as, and most likely, a greater number of breach events the enterprise 24 would otherwise be unaware of unless reported thereto, i.e., data breaches of entities outside of the enterprise 24, e.g., breach events to the workforce, other entities, corporations, etc. occurring both inside and outside of the enterprise 24. The information recovered with the breach records process 96 may be tabulated or otherwise accumulated into a repository of breached data. One non-limiting aspect of the present disclosure contemplates the breach records process 96 casting a wide net to uncover breaches associated with different industries, across platforms, and in virtually any environment within which commerce other transactions may take place that are subjected to breach events, and for which breached data is capable of being reported.

The breach record process 96 may include normalizing or otherwise processing the breached data into data types having data entries similar to that received as part of the monitored credentials process 54. A relation between the data sets may be beneficial in providing some overlap or some manner for comparing the monitored credentials to the breach records, i.e., for comparing the breachable data recovered as part of the monitor credentials process 54 with the breached data recovered as part of the breach records process 96. The risk management and protection method 50 may thereafter implement a compromised credentials process 98 to compare the breachable data to the breached data, or more specifically, to compare the monitored credentials to the records or breach credentials. The compromised credentials process 98 may include finding data entries overlapping or otherwise matching between the compromised credentials and the breach records. This may include cross-referencing otherwise matching the monitored credentials with the breach records to identify one or more compromised credentials 100. The compromised credentials 100 may correspond with the data entries having information identified in both of the monitored credentials and the breach records, which may point towards the underlying information being within the hands of a bad or a nefarious actor, and potentially available for use thereby in causing harm to the enterprise 24.

An output of the compromised credentials process may be an identification of one or more compromised credentials 100. The compromised credentials 100 may correspond with the monitored credentials identified to have been exposed or otherwise compromised as a result of a reported one or more of the data breaches, i.e., the monitor credentials having data matching with data identified in one or more of the breach records. Any number of compromised credentials 100 may be identified, and given the enterprise 24 may include hundreds, thousands, or more employees and/or vendors, with the potential for the number of identified compromised credentials to be vast. The monitor controller 52 may be configured to keep a running list and categorization of the compromised credentials over time. This accumulation of compromised credentials 100 may be useful in assessing relative risks to the enterprise 24 and otherwise generating a holistic view of security and financial risk posed to the enterprise 24 as a result of data breaches affecting the workforce thereafter influencing the security and financial risks of the enterprise 24.

The risk management and protection method 50 may include a threat matrix process 102 for processing the compromised credentials 100 through a threat matrix to determine a plurality of threat vectors 104, with each threat vector representing a threat to the enterprise 24 as a result of the compromised credentials 100. The threat matrix 102 may include a methodology for mapping compromised credentials 100 to the threat vectors 104, such as a set of threat rules for correlating the compromised credentials 100 to a relevant one or more of the threat vectors 104. The threat vectors 104 may be considered as representing a route, direction, scenario, or other manner for the associated compromised credential to influence the enterprise 24. One non-limiting aspect of the present disclosure contemplates the threat matrix assess 102 being configured to sift the compromised credentials 100 therethrough in order to connect the compromised credentials 100 to one or more of the threat vectors 104. The threat vectors 104 may be predefined or identified relative to cybercriminal activity enabled by the compromised credentials 100, such as by identifying the threat vectors 104 as a category or class of harmful activities undertaken by a bad actor in an attempt to weaponize a corresponding one or more of the compromised credentials 100 to attack the enterprise 24. The threat vectors 104, for example, may correspond with bank or credit card fraud, government benefits fraud, new business accounts, phishing (email, phone, and SMS), account take over attacks (ATO) (email, financial, business tool), employee social engineering, etc.

The risk management and protection method 50 may include an impact matrix process 108 for processing the threat vectors 104 through an impact matrix to determine a plurality of impact vectors 110, with each impact vector 110 representing an impact to the enterprise 24 as a result of the compromised credentials 100 and/or threat vectors 104. The impact matrix as 108 may include a methodology for mapping compromised credentials 100 and the threat vectors 104 to the impact vectors 110, such as a set of impact rules for correlating the compromised credentials 100 and the threat vectors 104 to a relevant one or more of the impact vectors 110. The impact vectors 110 may be considered as representing a route, direction, scenario, or other manner for deriving an impact to the enterprise 24 from the compromised credentials 100 and threat vectors 104. The impact matrix sets 108 may optionally include a user privilege process 112 input for adjusting the threat vectors 104 relative to the employee, vendor, or other workforce member based on corresponding a user profile or other methodology for weighting or scaling the impact vector 110 depending on a role, capability, or other position of the employee or vendor within the enterprise 24. The same compromised credentials 100 of a laborer and a CEO, for example, may produce the same threat vector 104, however, the impact vector 110 may rate the influence of the laborer impact vector to be less than that of the CEO due to the user profile or privileges of the CEO indicating the corresponding impact to be magnified.

One non-limiting aspect of the present disclosure contemplates having different user profiles, such as user profiles for business, finance, technology, sales, marketing, customer service, human resources, operations, management/strategy, legal, compliance, bored, etc. The user profiles may be correspondingly applied to the impact vectors 110 to relatedly adjust the influence thereof. One non-limiting aspect of the present disclosure contemplates leveraging the user profiles and the impacts matrix process 108 to identify enterprise impacts to the enterprise 24 according to impacts for data theft or tampering impact, ransomware, a corporate card fraud, fraudulent disbursements impact, fraudulent business loans, and/or a government program fraud impact. The impact vectors 110, at least in this manner, may represent aspects of the business likely to be or at risk of being attacked by a bad actor using the means and capabilities provided through the corresponding threat vector 104 and/or compromised credential 100. The impact vectors 110 may be considered, at least in this regard and in a non-limiting manner, as a result or a product of an attack, whereas the compromised credentials 100 and the threat vectors 104 may be considered as a means for undertaking or otherwise engaging in attack, i.e., the compromised credentials 100 and the threat vectors 104 may be a means for an attack and the impact vectors 110 may be a conclusion of that attack.

The risk management and protection method 50 may include a preventative actions processes 116 for relating the threat vectors 104 and the impact vectors 110 to corrective actions or other activities to be undertaken by the enterprise 24 in relation to the compromised credentials 100, the threat vectors 104, and the impact vectors 110, such as to mitigate resulting harm to the enterprise 24. The preventative action process 116 may correspond with a vector action link process 118 and an impact action links process 120. The vector action links process 118 may be used to generate one or more links to one or more actions 122 to be undertaken in response to the threat vector 104 associated therewith, i.e., actions to be taken to prevent the bad actor from using the compromised credentials 100. The impact action links process 120 may be used to generate one or more links to one or more actions 122 to be undertaken in response to the impact vector 110 associated therewith, i.e., actions 122 to be taken to mitigate the severity or the result of the bad actor succeeding in undertaking an attack. The links may be used to generate an action output 122 identifying one or more corrective enterprise actions to be undertaken by the enterprise 24 to mitigate the influence of the threat vectors 104 and/or impact vectors 110, which optionally may correspond with a predefined set of corrective actions, such as actions 122 to activate two-factor authentication action, reset compromised passwords, set of offsite and offline backups, manager user behavior to support DLP strategy, and audit privileges are access and revoke if needed.

The risk management and protection method 50 may include a number of processes configured to facilitate identifying breachable data for the workforce that is likely to be subjected to attack (monitor credentials), comparing the collecting information to breach events that may affect the workforce and/or the enterprise 24 (breach records), and comparing the two sets of information to identify information capable of or having a potential or a probability for being used against the enterprise 24 (compromised credentials 100). The risk management and protection method 50 may additionally include a number of additional processes for identifying ways compromised credentials 100 may be weaponized into attack methodologies against the enterprise 24 (threat vectors 104), the resulting business influence stemming from the attack methodologies (business impacts or impact vectors 110), and corrective or preventative measures that may be undertaken to mitigate the effect thereof (enterprise actions 122). The severity, scope, influence, performance, metrics, and other values generated as a result of the process and otherwise related to thereto may be calculated and presented within the enterprise risk protection interface 26 to provide normalization and context to the associated events, activities, etc., which may be useful in rendering the underlying information into a visual assemblage (enterprise risk protection interface) capable of providing a holistic view of security in financial risks posed to the enterprise 24.

The presentation and accumulation of security and protection related information contemplated herein may be beneficial to operators 28 of the enterprise 24 as such operators 28 have had a long felt need to understand and manage security risks, particularly accumulated security risks, after a breach as occurred, and to have some measure thereafter for understanding protective actions 122 the operator 28 or enterprise should be taken as a consequence. One non-limiting aspect of the present disclosure contemplates a need for operators 28 to understand their business risk, identify the right technology to support those risk, and understand activities leading to risk. The information presented through the dashboard menu 30 and otherwise described herein may be particularly helpful in allowing operators 28 to address fraud concerns, particularly as some fraud concerns may supersede security risk for some enterprises. The relationship between compromised credentials 100 and risk to the enterprise 24 may be particularly useful in identifying fraudulent transfers from one business financial account to another, compromised vendor systems that may have exposed data for the enterprise 24, new financial accounts opened using the enterprise's 24 identity, unauthorized access to other business systems (e.g., cloud environment or customer management system), and/or unauthorized access to employee email accounts.

Returning to FIG. 2, the enterprise 24 risk protection interface, particularly when considered in light of the risk management and protection method 50 described herein, presents capabilities of the risk management and protection method 50 to illuminate fraud and security risks created by the compromise of enterprise's 24 workforce and the potentialities resulting therefrom. One non-limiting aspect of the present disclosure contemplates generating an accumulated enterprise risk score 126 for display within the accumulated risk callout portion 40 of the dashboard menu 30. The accumulated enterprise risk score 126 may be used to present a performance metric for holistically reporting the security and financial risks posed to the enterprise 24. The accumulated enterprise risk score 126 may be generated as a color-coded numerical value defined relative to a normalized harm scale, which for exemplary purposes comprises a numerical value being between 0 and 100. The numerical value may be color-coded green when the accumulated enterprise risk score is low, yellow when the accumulated enterprise risk score is medium, and red when the accumulated enterprise risk score is high.

The accumulated risk score 126 may be a summation or a high-level assessment of current, accumulated risks posed to the enterprise 24, which may be useful to the operator 28 in quickly assessing at-a-glance any threats to the enterprise 24. The accumulated risk score 26 may change on a daily basis, such as in response to corrective actions 122 taken by the enterprise 24 and/or deprecation of threat vectors 104 and/or impact vectors 110, e.g., over time the threat and impact vectors 110 may expect be deprecated or metered as the likelihood of a corresponding attack decreases over time. One non-limiting aspect of the present disclosure contemplates an operator 28 logging into the dashboard menu 30 on a daily basis, or to be emailed or otherwise provided a summary report on a daily basis, whereby the operator 28 may assess the day's level of risk with a quick inspection of the accumulated risk score. The high level score-based summary 126 may be beneficial in enabling the operator 28 to assess risk without having to individually assess what may be a vast number of data breaches and compromises, and to do so with the relative ease of the normalized scale numerical and color-coded scaling.

One non-limiting aspect of the present disclosure contemplates threats and impacts to the enterprise 24 as a result of compromises to its employees, vendors, and other members of the workforce. In an effort to provide the operator 28 with a view of the quantity of vendors and employees being monitored for this purpose, a vendor summary 130 may be generated within the vendor callout 132 portion of the dashboard menu 30. The vendor summary 130 may be used for indicating a quantity of vendors identified in the monitored credentials and a quantity of the vendors identified to be high risk. An employee summary 134 may be similarly generated within an employee callout 136 portion of the dashboard menu 30. The employee summary 134 may be similarly used for indicating a quantity of employees identified in the monitored credentials and a quantity of the employees identified as being high risk. The vendor and employee summaries 130, 134 are shown as being positioned relative to the accumulated risk score 126 as one non-limiting aspect of the present disclosure contemplates value in understanding a close relationship between accumulated risk score is six and the quantity of vendors and employees being monitored, particularly with the quantity thereof deemed to be high risk being noted, which may be beneficial in providing the operator 28 with an overview of the risk situation.

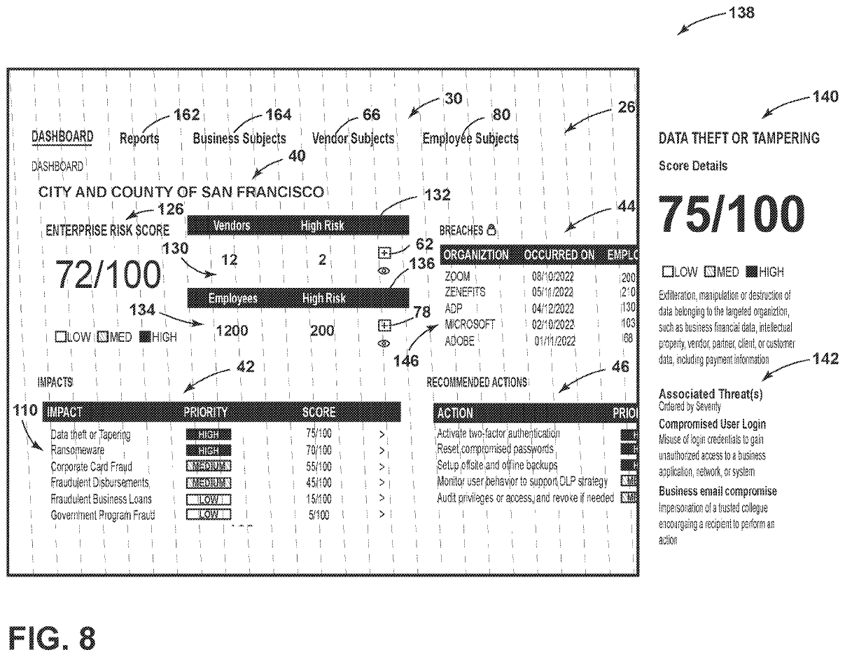

The dashboard menu 30 may include the impacts callout 42 portion for displaying a plurality of security and financial impacts to the enterprise 24, which as described above may corresponding with the impact vectors 110 determined as part of the impact matrix process 102. The impacts callout 42 portion may include a running or an accumulating listing of the impact vectors 110 within each impact category being arranged according to a harm priority and a harm score displayed relative thereto. The impacts callout 42 portion is shown to include categories for a data theft or tampering impact, a ransomware impact, a corporate card fraud impact, a fraudulent disbursements impact, a fraudulent business loans impact, and/or a government program fraud impact. The harm priority and the harm score for each of the impact categories may be based on an accumulative risk of the enterprise 24 risk for each of the impact categories. The accumulative effect may be a representation of multiple impact vectors 110 being included within to the impact categories such that the harm priority and harm score of each may be a summation or a total of the resulting effect, which may increase or decrease depending on the quantity and/or the severity oof breaches included therein. As more and more breaches relate to a particular one of the impact categories, for example, the related harm priority and score may potentially increase with each addition breach event until corrective actions 122 are undertaken. An impact explanation page for each of the impacts may be accessible for providing the operator 28 with meaningful information to help in understanding the impacts. FIG. 8 illustrates a data theft or tampering impact explanation page 138 in accordance with one non-limiting aspect of the present disclosure. A callout chevron included within the dashboard menu 30 may be clicked to access the explanation page 138, which in turn may present an impact summary 140 and one or more associated threats 142 for the impact related therewith.

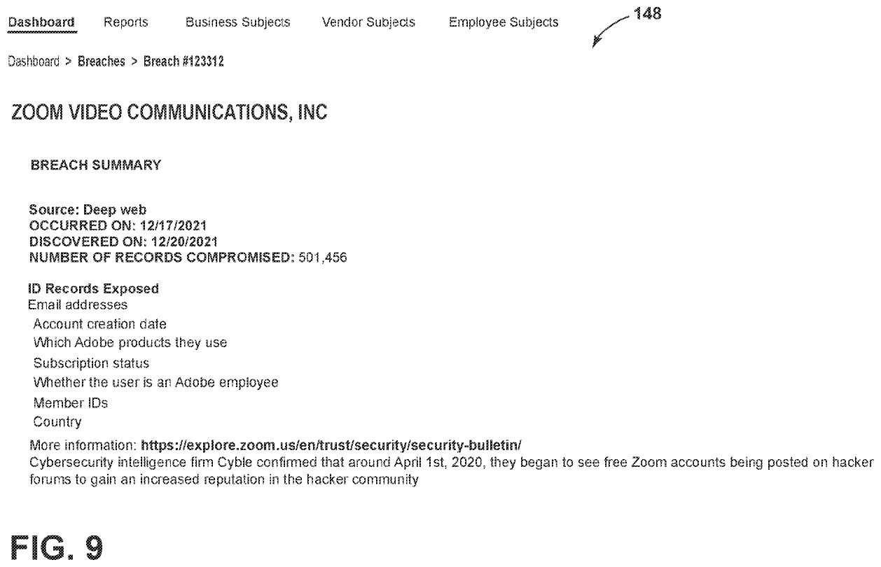

Returning to FIG. 2, the dashboard menu 30 may include a breach history profile 146 for displaying within the breach history callout 44 portion for listing one or more of the data breaches resulting in one or more of the compromised credentials 100. The breach information included within the breach history profile 146 for each of the data breaches listed may include a breached identity or organization, an occurrence date, a quantity of affected employees, and a quantity of affected vendors. Information may be determined as part of the breach records assess, i.e., as a function of breaches reported to the enterprise 24, which may optionally be automatically incorporated or otherwise electronically obtained. A breach explanation page 148 for each of the data breaches listed in the breach history profile 146 to provide the operator 28 with detailed information for each of the listed breaches. FIG. 9 illustrates the breach explanation page 148 in accordance with one-limiting aspect of the present disclosure for a zoom communication breach. A similar breach explanation page 148 may be accessible through the breach history callout 42 and configured for describing a breach summary for the data breach associated therewith. The breach explanation page 148 may present the operator 28 with the data entries for each of the data types included within the breach records, which may include data entries for a source, an occurrence date, a discovery date, a number of enterprise records compromised, and an identifier for each type of the enterprise 24 records compromises.

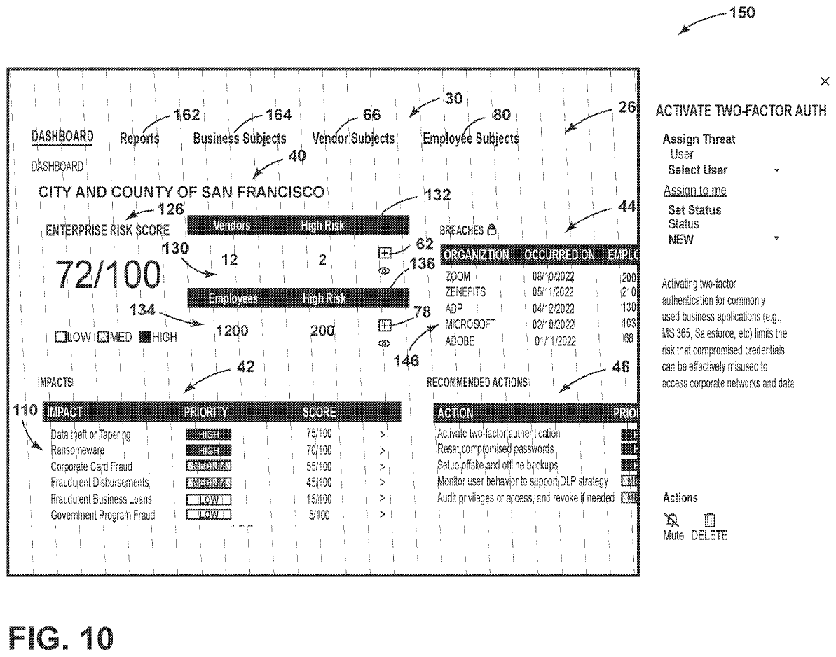

Returning to FIG. 2, the dashboard menu 30 may include a plurality of recommended actions 122 for display within the recommended actions callout 46 portion. The recommended actions 122 may correspond with the enterprise 24 actions determined as part of the preventative action process described above. The recommended actions 122 are shown for illustrative purposes as being assigned an action priority, an effort expected, an action status, and an action assignee. The action priority may be used to provide feedback to the operator 28 as to a need for implementing the corresponding recommended action, which may be based on multiple breaches and/or a severity of quickness that the corresponding action is implementation. The status may be a useful measure for quickly assessing progress in implementing the corresponding action, which for exemplary purposes are shown to be new, completed, blocked or active. This information may be show and enabling the operator 28 to determine whether ours is being made or whether operator 28 should engage or request assistance. The action assignee may be a point of contact for addressing the corresponding recommended action. A recommendation explanation page 150 may be accessible for each of the recommended actions. FIG. 10 illustrates an activate two-factor authentication recommendation explanation page 150 in accordance with non-limiting aspect of the present disclosure for describing an action summary and for selecting the action assignee and the action status for the recommended action associated therewith. The explanation page 150 may additionally include a mute button and a delete button.

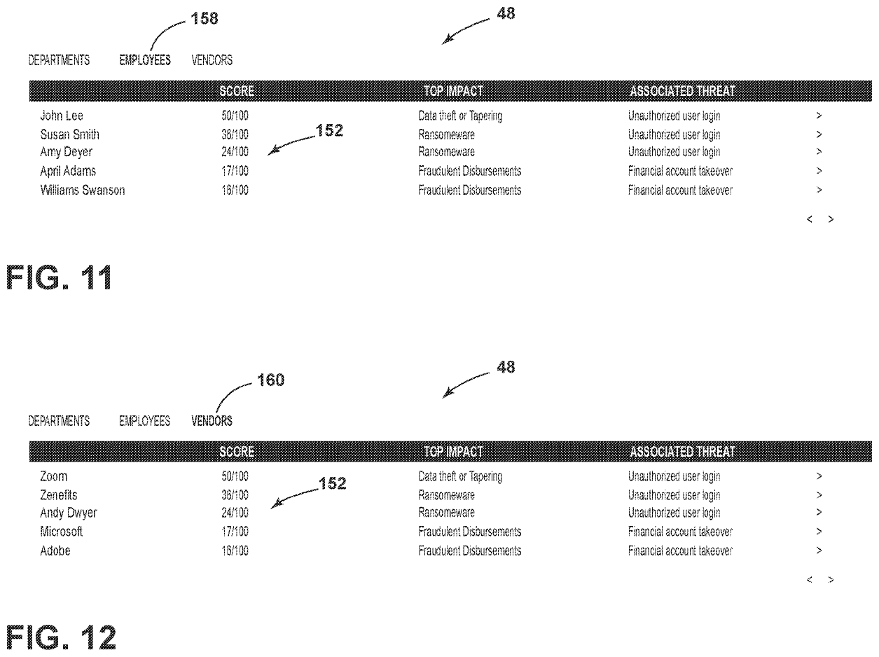

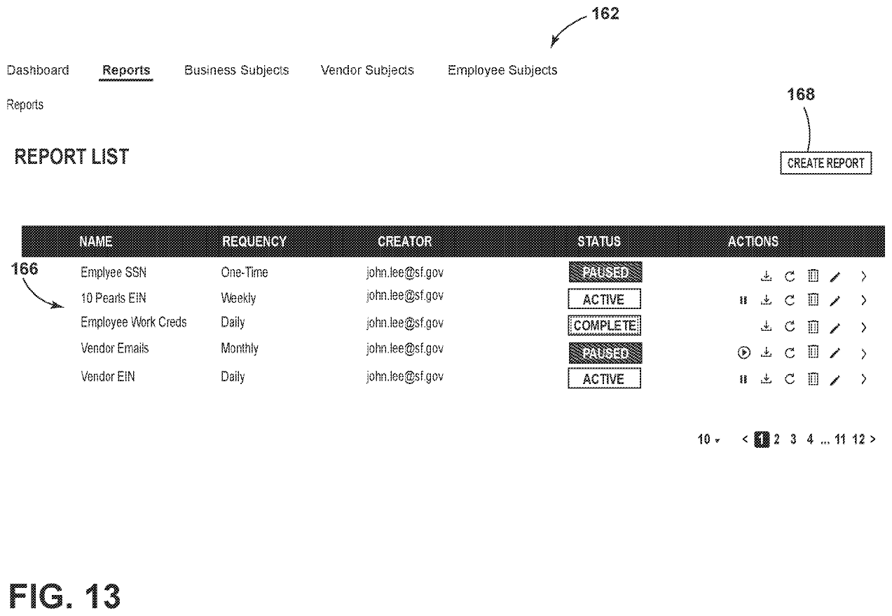

Returning to FIG. 2, the dashboard menu 30 may include a plurality of subject accumulated risk scores 152 for a plurality of subjects within the subjects callout 48. The subject accumulated risk scores 152 may represent accumulated risk for the data breach of the subject associated therewith, which may be sortable according to a departments category 156, an employees category 158, and an vendors category 160, with each subject being individually selectable to display the subject accumulated risk scores, a top impact, and a top associated threat for the subject associated therewith. FIG. 2 illustrates the cumulative risk scores 152 associated with sorting the subjects callout 48 according to the departments category 156. FIG. 11 illustrates the cumulative risk scores 152 associated with sorting the subjects callout 48 according to the employees category 158 in accordance with one non-limiting aspect of the present disclosure. FIG. 12 illustrates the cumulative risk scores 152 associated with sorting the subjects callout 48 according to the vendors category 160 in accordance with one non-limiting aspect of the present disclosure.

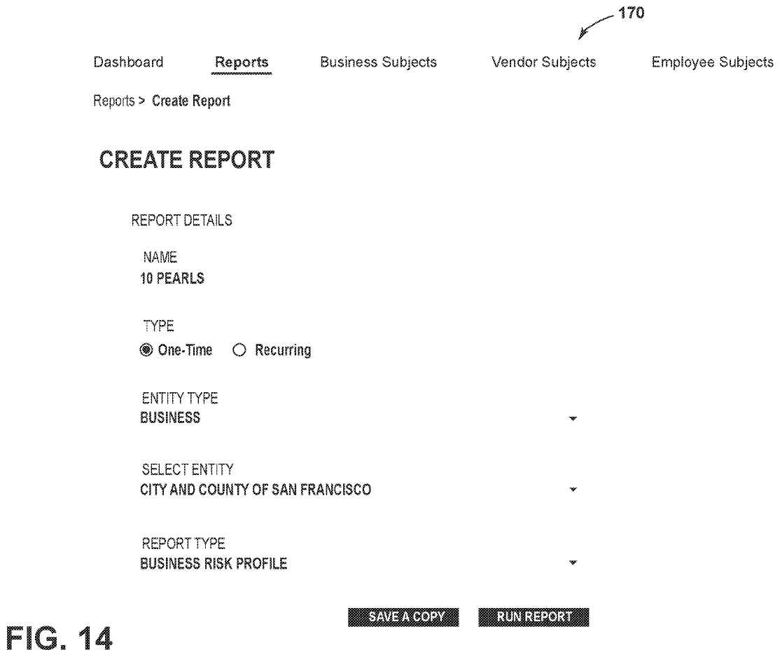

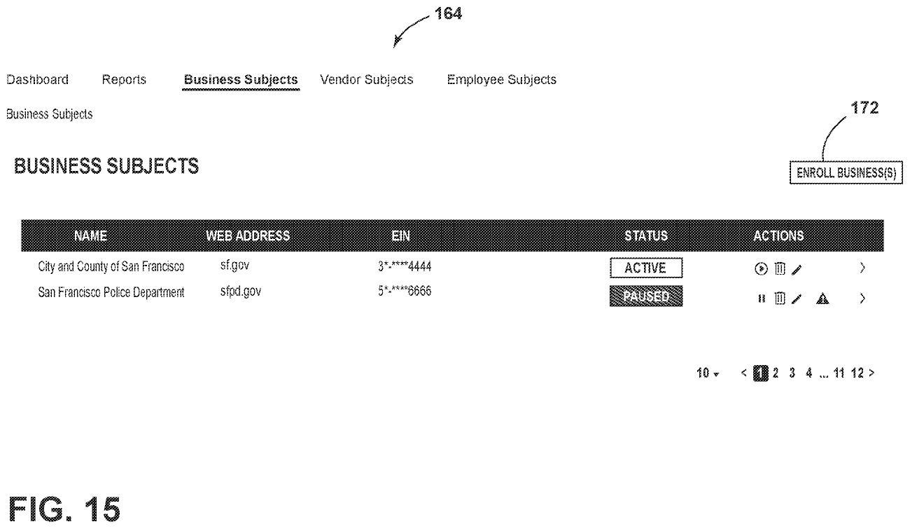

Returning to FIG. 2, a plurality of additional menus may be included within the enterprise 24 risk protection interface to augment the dashboard menu 30, which are shown for exemplary purposes to include a reports menu 162 and a business subjects menu 164. FIG. 13 illustrates the reports menu 162 in accordance with one non-limiting aspect of the present disclosure. The reports menu 162 may be selected to display a plurality of reports 166 capable of being generated for the operator 28, which may be optionally automatically generated to provide feedback to the operator 28, such as through email or other reporting mechanisms. A plurality of exemplary reports 166 are illustrated according to a name, a frequency, a creator, a status, and a plurality of available actions. A create report button 168 may be included to facilitate the operator 28 generating a new or a customized report. FIG. 14 illustrates a report generation page 170 in accordance with one non-limiting aspect of the present disclosure that may be accessible through the create report button. The report generation page 170 may be used to generate a report, optionally with the report including a plurality of data fields, which are shown for exemplary purposes to include a name, a type selection menu, an entity type drop-down menu, select entity drop-down menu, and a report type drop-down menu.

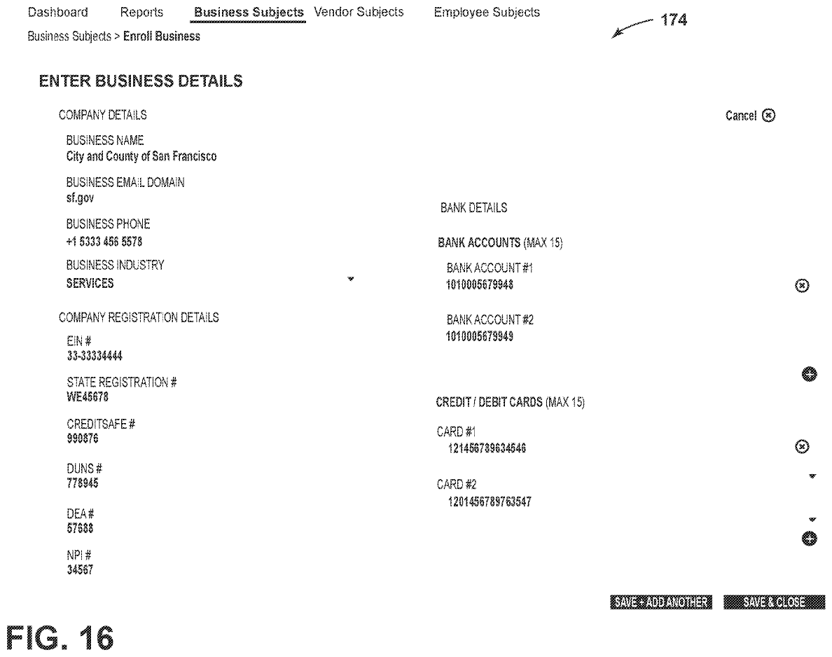

FIG. 15 illustrates the business subjects menu 164 in accordance with one non-limiting aspect of the present disclosure. The subjects menu 164 may be selected to individually assess business entities, groups, subsidiaries, or other subsets of the enterprise 24, such as to select portions of the enterprise 24 to be enrolled within the enterprise 24 risk management and protection system 10. The subjects menu 164 may include a plurality of business groups, organize according to name, web address, EIN, enrollment status, and a plurality of available actions. An enroll business button 172 may be included to facilitate the operator 28 enrolling another business entity for monitoring. FIG. 16 illustrates an enter business details page 174 available for inputting the monitored credentials for one of the business entities in accordance with one non-limiting aspect of the present disclosure. The enter business details page 174 is shown for exemplary and non-limiting purposes with respect to an entry form type of configuration whereby data types correspond with a company details section, a company registration details section, and a bank details using data entries similar to that described above with respect to the vendor subjects menu.

The following Clauses provide example configurations of the method and system for enterprise risk management disclosed herein.
Clause 1. A method for enterprise risk management and protection, comprising: receiving a plurality of monitored credentials for employees and vendors working for an enterprise, the monitored credentials being susceptible to exposure in the event one or more of the employees or vendors associated therewith is compromised; receiving a plurality of breach records for a plurality of data breaches, each breach record representing breached data exposed as a result of the data breach associated therewith; comparing the monitored credentials to the breached data to identify one or more compromised credentials, the compromised credentials representing the monitored credentials exposed as a result of the data breaches; and generating a dashboard to visually provide a holistic view of security and financial risks posed to the enterprise as a result of the compromised credentials, the dashboard being electronically displayable through a user interface.
Clause 2. The method according to clause 1, further comprising: generating an accumulated enterprise risk score for display within an accumulated risk callout portion of the dashboard, the accumulated enterprise risk score presenting a performance metric for holistically reporting the security and financial risks posed to the enterprise.
Clause 3. The method according to clauses 1-2, further comprising: displaying the accumulated enterprise risk score as a numerical value color-coded and defined relative to a normalized harm scale, the numerical value being between 0 and 100 and color-coded green when the accumulated enterprise risk score is low, yellow when the accumulated enterprise risk score is medium, and red when the accumulated enterprise risk score is high.
Clause 4. The method according to clauses 1-3, further comprising: generating a vendor summary within a vendor callout portion of the dashboard, the vendor summary indicating a quantity of vendors identified in the monitored credentials and a quantity of the vendors identified to be high risk.
Clause 5. The method according to clauses 1-4, further comprising: generating an employee summary within an employee callout portion of the dashboard, the employee summary indicating a quantity of employees identified in the monitored credentials and a quantity of the employees identified as being high risk.
Clause 6. The method according to clauses 1-5, further comprising: generating a plurality of security and financial impacts for display within an impacts callout portion of the dashboard, including displaying a harm priority and a harm score relative to each of the impacts.
Clause 7. The method according to clauses 1-6, further comprising: generating the impacts to include at a data theft or tampering impact, a ransomware impact, a corporate card fraud impact, a fraudulent disbursements impact, a fraudulent business loans impact, and/or a government program fraud impact, with the harm priorities and the harm scores being displayed in a relative relationship to the impact associated therewith.
Clause 8. The method according to clauses 1-7, further comprising: generating an impact explanation page for each of the impacts, each impact explanation page being accessible through the impacts callout and configured for describing an impact summary and one or more associated threats for the impact related therewith.
Clause 9. The method according to clauses 1-8, further comprising: generating a breach history profile for display within a breach history callout portion of the dashboard, including listing in the breach history profile one or more of the data breaches resulting in one or more of the compromised credentials.
Clause 10. The method according to clauses 1-9, further comprising: including breach information within the breach history profile for each of the data breaches listed therein, the breach information indicating a breached identity, an occurrence date, a quantity of affected employees, and a quantity of affected vendors.
Clause 11. The method according to clauses 1-10, further comprising: generating a breach explanation page for each of the data breaches listed in the breach history profile, each breach explanation page being accessible through the breach history callout and configured for describing a breach summary for the data breach associated therewith.
Clause 12. The method according to clauses 1-11, wherein: each summary identifies a source, an occurrence date, a discovery date, a number of enterprise records compromised, and an identifier for each type of the enterprise records compromises.
Clause 13. The method according to clauses 1-12, further comprising: generating a plurality of recommended actions for display within a recommended actions callout portion of the dashboard, including associating an action priority, an action status, and an action assignee with each of the recommended actions, and displaying the recommended actions relative to the action priority associated therewith.
Clause 14. The method according to clauses 1-13, further comprising: generating a recommendation explanation page for each of the recommended actions, each recommendation explanation page being accessible through the recommended actions callout for describing an action summary and for selecting the action assignee and the action status for the recommended action associated therewith.
Clause 15. The method according to clauses 1-14, further comprising: generating a subject accumulated risk score for a plurality of subjects for display within a subjects callout of the dashboard, the subject accumulated risk scores representing accumulated risk for the data breach of the subject associated therewith.
Clause 16. The method according to clauses 1-15, further comprising: generating the subjects callout to be sortable according to a departments category, an employees category, and an vendors category, with each subject being individually selectable to display the subject accumulated risk score, a top impact, and a top associated threat for the subject associated therewith.
Clause 17. The method according to clauses 1-16, further comprising: processing the compromised credentials through a threat matrix to determine a plurality of threat vectors, each threat vector representing a threat to the enterprise as a result of the compromised credentials.
Clause 18. The method according to clauses 1-17, wherein: the threat matrix defines a plurality of vector links to be used in mapping data entries of the compromised credentials relative to the threat vectors.
Clause 19. The method according to clauses 1-18, further comprising: processing the compromised credentials and the threat vectors through an impacts matrix to determine a plurality of impact vectors, each impact vectors representing an impact on the enterprise as a result of the compromised credentials and threat vectors.
Clause 20. The method according to clauses 1-19, wherein: the impacts matrix defines a plurality of impact links to be used in mapping the compromised credentials and the threat vectors to one or more of the impact vectors.
Clause 21. The method according to clauses 1-20, further comprising: assessing the compromised credentials, the threat vectors, and the impact vectors relative to a corrective actions matrix to determine a plurality of corrective actions, each corrective action representing an enterprise action to be taken by the enterprise to mitigate the influence of the threat vector and/or the impact associated therewith.
Clause 22. The method according to clauses 1-21, wherein: the corrective actions matrix defines a plurality of action links to be used in mapping the compromised credentials, the threat vectors, and the impact vectors to one or more of the corrective actions.
Clause 23. An electronic device, comprising: at least one processor; a memory communicatively coupled to the at least one processor; and the memory stores instructions executable by the at least one processor to perform the method of clauses 1-22.
Clause 24. A non-transitory computer readable storage medium, storing computer instructions to enable a computer to perform the method of clauses 1-22.
Clause 25. A computer program product, comprising a computer program, wherein the computer program is executed by a processor to perform the method of clause 1-22.
Clause 26. An enterprise risk management and protection system, comprising: a monitored credentials controller configured for receiving a plurality of monitored credentials for employees and vendors working for an enterprise, the monitored credentials being susceptible to exposure in the event one or more of the employees or vendors associated therewith is compromised; a breach records controller configured for receiving a plurality of breach records for a plurality of data breaches, each breach record representing breached data exposed as a result of the data breach associated therewith; a compromised credentials controller configured for comparing the monitored credentials to the breached data to identify one or more compromised credentials, the compromised credentials representing the monitored credentials exposed as a result of the data breaches; and a monitor controller configured for generating a dashboard to visually provide a holistic view of security and financial risks posed to the enterprise as a result of the compromised credentials, the dashboard being electronically displayable through a user interface.
Clause 27. The enterprise risk management and protection system according to clause 26, wherein: the monitor controller is configured for generating an accumulated enterprise risk score for display within an accumulated risk callout portion of the dashboard, the accumulated enterprise risk score presenting a performance metric for holistically reporting the security and financial risks posed to the enterprise.
Clause 28. The enterprise risk management and protection system according to clauses 26-27, wherein: the monitor controller is configured for displaying the accumulated enterprise risk score as a numerical value color-coded and defined relative to a normalized harm scale, the numerical value being between 0 and 100 and color-coded green when the accumulated enterprise risk score is low, yellow when the accumulated enterprise risk score is medium, and red when the accumulated enterprise risk score is high.
Clause 29. The enterprise risk management and protection system according to clauses 26-28, wherein: the monitor controller is configured for generating a vendor summary within a vendor callout portion of the dashboard, the vendor summary indicating a quantity of vendors identified in the monitored credentials and a quantity of the vendors identified to be high risk.
Clause 30. The enterprise risk management and protection system according to clauses 26-29, wherein: the monitor controller is configured for generating an employee summary within an employee callout portion of the dashboard, the employee summary indicating a quantity of employees identified in the monitored credentials and a quantity of the employees identified as being high risk.
Clause 31. The enterprise risk management and protection system according to clauses 26-30, wherein: the monitor controller is configured for generating a plurality of security and financial impacts for display within an impacts callout portion of the dashboard, including displaying a harm priority and a harm score relative to each of the impacts.
Clause 32. The enterprise risk management and protection system according to clauses 26-31, wherein: the monitor controller is configured for generating the impacts to include at a data theft or tampering impact, a ransomware impact, a corporate card fraud impact, a fraudulent disbursements impact, a fraudulent business loans impact, and/or a government program fraud impact, with the harm priorities and the harm scores being displayed in a relative relationship to the impact associated therewith.
Clause 33. The enterprise risk management and protection system according to clauses 26-32, wherein: the monitor controller is configured for generating an impact explanation page for each of the impacts, each impact explanation page being accessible through the impacts callout and configured for describing an impact summary and one or more associated threats for the impact related therewith.
Clause 34. The enterprise risk management and protection system according to clauses 26-33, wherein: the monitor controller is configured for generating a breach history profile for display within a breach history callout portion of the dashboard, including listing in the breach history profile one or more of the data breaches resulting in one or more of the compromised credentials.
Clause 35. The enterprise risk management and protection system according to clauses 26-34, wherein: the monitor controller is configured for including breach information within the breach history profile for each of the data breaches listed therein, the breach information indicating a breached identity, an occurrence date, a quantity of affected employees, and a quantity of affected vendors.
Clause 36. The enterprise risk management and protection system according to clauses 26-35, wherein: the monitor controller is configured for generating a breach explanation page for each of the data breaches listed in the breach history profile, each breach explanation page being accessible through the breach history callout and configured for describing a breach summary for the data breach associated therewith.
Clause 37. The enterprise risk management and protection system according to clauses 26-36, wherein: each summary identifies a source, an occurrence date, a discovery date, a number of enterprise records compromised, and an identifier for each type of the enterprise records compromises.
Clause 38. The enterprise risk management and protection system according to clauses 26-37, wherein: the monitor controller is configured for generating a plurality of recommended actions for display within a recommended actions callout portion of the dashboard, including associating an action priority, an action status, and an action assignee with each of the recommended actions, and displaying the recommended actions relative to the action priority associated therewith.
Clause 39. The enterprise risk management and protection system according to clauses 26-38, wherein: the monitor controller is configured for generating a recommendation explanation page for each of the recommended actions, each recommendation explanation page being accessible through the recommended actions callout for describing an action summary and for selecting the action assignee and the action status for the recommended action associated therewith.
Clause 40. The enterprise risk management and protection system according to clauses 26-39, wherein: the monitor controller is configured for risk score for a plurality of subjects for display within a subjects callout of the dashboard, the subject accumulated risk scores representing accumulated risk for the data breach of the subject associated therewith.
Clause 41. The enterprise risk management and protection system according to clauses 26-40, wherein: the monitor controller is configured for generating the subjects callout to be sortable according to a departments category, an employees category, and an vendors category, with each subject being individually selectable to display the subject accumulated risk score, a top impact, and a top associated threat for the subject associated therewith.
Clause 42. The enterprise risk management and protection system according to clauses 26-41, further comprising: a threat matrix controller configured for determining a plurality of threat vectors, each threat vector representing a threat to the enterprise as a result of the compromised credentials.
Clause 43. The enterprise risk management and protection system according to clauses 26-42, wherein: the threat matrix defines a plurality of vector links to be used in mapping data entries of the compromised credentials relative to the threat vectors.
Clause 44. The enterprise risk management and protection system according to clauses 26-43, further comprising: an impacts matrix controller configured for processing the compromised credentials and the threat vectors through an impacts matrix to determine a plurality of impact vectors, each impact vectors representing an impact on the enterprise as a result of the compromised credentials and threat vectors.
Clause 45. The enterprise risk management and protection system according to clauses 26-44, wherein: the impacts matrix controller defines a plurality of impact links to be used in mapping the compromised credentials and the threat vectors to one or more of the impact vectors.
Clause 46. The enterprise risk management and protection system according to clauses 26-45, further comprising: a preventive actions controller configured for assessing the compromised credentials, the threat vectors, and the impact vectors relative to a corrective actions matrix to determine a plurality of corrective actions, each corrective action representing an enterprise action to be taken by the enterprise to mitigate the influence of the threat vector and/or the impact associated therewith.
Clause 47. The enterprise risk management and protection system according to clauses 26-46, wherein: the corrective actions matrix defines a plurality of action links to be used in mapping the compromised credentials, the threat vectors, and the impact vectors to one or more of the corrective actions.

The terms “comprising”, “including”, and “having” are inclusive and therefore specify the presence of stated features, steps, operations, elements, or components, but do not preclude the presence or addition of one or more other features, steps, operations, elements, or components. Orders of steps, processes, and operations may be altered when possible, and additional or alternative steps may be employed. As used in this specification, the term “or” includes any one and all combinations of the associated listed items. The term “any of” is understood to include any possible combination of referenced items, including “any one of” the referenced items. “A”, “an”, “the”, “at least one”, and “one or more” are used interchangeably to indicate that at least one of the items is present. A plurality of such items may be present unless the context clearly indicates otherwise. All numerical values of parameters (e.g., of quantities or conditions), unless otherwise indicated expressly or clearly in view of the context, including the appended claims, are to be understood as being modified in all instances by the term “about” whether or not “about” actually appears before the numerical value. A component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

While various embodiments have been described, the description is intended to be exemplary, rather than limiting and it will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims. Although several modes for carrying out the many aspects of the present teachings have been described in detail, those familiar with the art to which these teachings relate will recognize various alternative aspects for practicing the present teachings that are within the scope of the appended claims. It is intended that all matter contained in the above description or shown in the accompanying drawings shall be interpreted as illustrative and exemplary of the entire range of alternative embodiments that an ordinarily skilled artisan would recognize as implied by, structurally and/or functionally equivalent to, or otherwise rendered obvious based upon the included content, and not as limited solely to those explicitly depicted and/or described embodiments.

1. A method for enterprise risk management and protection, comprising:
receiving a plurality of monitored credentials for employees and vendors working for an enterprise, the monitored credentials being susceptible to exposure in the event one or more of the employees or vendors associated therewith is compromised;
receiving a plurality of breach records for a plurality of data breaches, each breach record representing breached data exposed as a result of the data breach associated therewith;
comparing the monitored credentials to the breached data to identify one or more compromised credentials, the compromised credentials representing the monitored credentials exposed as a result of the data breaches; and
generating a dashboard to visually provide a holistic view of security and financial risks posed to the enterprise as a result of the compromised credentials, the dashboard being electronically displayable through a user interface.

2. The method according to claim 1, further comprising:
generating an accumulated enterprise risk score for display within an accumulated risk callout portion of the dashboard, the accumulated enterprise risk score presenting a performance metric for holistically reporting the security and financial risks posed to the enterprise.

3. The method according to claim 2, further comprising:
displaying the accumulated enterprise risk score as a numerical value color-coded and defined relative to a normalized harm scale, the numerical value being between 0 and 100 and color-coded green when the accumulated enterprise risk score is low, yellow when the accumulated enterprise risk score is medium, and red when the accumulated enterprise risk score is high.

4. The method according to claim 3, further comprising:
generating a vendor summary within a vendor callout portion of the dashboard, the vendor summary indicating a quantity of vendors identified in the monitored credentials and a quantity of the vendors identified to be high risk.

5. The method according to claim 4, further comprising:
generating an employee summary within an employee callout portion of the dashboard, the employee summary indicating a quantity of employees identified in the monitored credentials and a quantity of the employees identified as being high risk.

6. The method according to claim 1, further comprising:
generating a plurality of security and financial impacts for display within an impacts callout portion of the dashboard, including displaying a harm priority and a harm score relative to each of the impacts.

7. The method according to claim 6, further comprising:
generating the impacts to include at a data theft or tampering impact, a ransomware impact, a corporate card fraud impact, a fraudulent disbursements impact, a fraudulent business loans impact, and/or a government program fraud impact, with the harm priorities and the harm scores being displayed in a relative relationship to the impact associated therewith.

8. The method according to claim 6, further comprising:
generating an impact explanation page for each of the impacts, each impact explanation page being accessible through the impacts callout and configured for describing an impact summary and one or more associated threats for the impact related therewith.

9. The method according to claim 1, further comprising:
generating a breach history profile for display within a breach history callout portion of the dashboard, including listing in the breach history profile one or more of the data breaches resulting in one or more of the compromised credentials.

10. The method according to claim 9, further comprising:
including breach information within the breach history profile for each of the data breaches listed therein, the breach information indicating a breached identity, an occurrence date, a quantity of affected employees, and a quantity of affected vendors.

11. The method according to claim 9, further comprising:
generating a breach explanation page for each of the data breaches listed in the breach history profile, each breach explanation page being accessible through the breach history callout and configured for describing a breach summary for the data breach associated therewith.

12. The method according to claim 11, wherein:
each summary identifies a source, an occurrence date, a discovery date, a number of enterprise records compromised, and an identifier for each type of the enterprise records compromises.

13. The method according to claim 1, further comprising:
generating a plurality of recommended actions for display within a recommended actions callout portion of the dashboard, including associating an action priority, an action status, and an action assignee with each of the recommended actions, and displaying the recommended actions relative to the action priority associated therewith.

14. The method according to claim 13, further comprising:
generating a recommendation explanation page for each of the recommended actions, each recommendation explanation page being accessible through the recommended actions callout for describing an action summary and for selecting the action assignee and the action status for the recommended action associated therewith.

15. The method according to claim 13, further comprising:
generating a subject accumulated risk score for a plurality of subjects for display within a subjects callout of the dashboard, the subject accumulated risk scores representing accumulated risk for the data breach of the subject associated therewith.

16. The method according to claim 15, further comprising:
generating the subjects callout to be sortable according to a departments category, an employees category, and an vendors category, with each subject being individually selectable to display the subject accumulated risk score, a top impact, and a top associated threat for the subject associated therewith.

17. The method according to claim 1, further comprising:
processing the compromised credentials through a threat matrix to determine a plurality of threat vectors, each threat vector representing a threat to the enterprise as a result of the compromised credentials.

18. The method according to claim 17, wherein:
the threat matrix defines a plurality of vector links to be used in mapping data entries of the compromised credentials relative to the threat vectors.

19. The method according to claim 18, further comprising: processing the compromised credentials and the threat vectors through an impacts matrix to determine a plurality of impact vectors, each impact vectors representing an impact on the enterprise as a result of the compromised credentials and threat vectors.

20. The method according to claim 19, wherein:
the impacts matrix defines a plurality of impact links to be used in mapping the compromised credentials and the threat vectors to one or more of the impact vectors.

21. The method according to claim 20, further comprising:
assessing the compromised credentials, the threat vectors, and the impact vectors relative to a corrective actions matrix to determine a plurality of corrective actions, each corrective action representing an enterprise action to be taken by the enterprise to mitigate the influence of the threat vector and/or the impact associated therewith.

22. The method according to claim 22, wherein:
the corrective actions matrix defines a plurality of action links to be used in mapping the compromised credentials, the threat vectors, and the impact vectors to one or more of the corrective actions.

23. An electronic device, comprising:
at least one processor;
a memory communicatively coupled to the at least one processor; and
the memory stores instructions executable by the at least one processor to perform the method of claims 1-22.

24. A non-transitory computer readable storage medium, storing computer instructions to enable a computer to perform the method of claims 1-22.

25. A computer program product, comprising a computer program, wherein the computer program is executed by a processor to perform the method of claims 1-22.

26. An enterprise risk management and protection system, comprising:
a monitored credentials controller configured for receiving a plurality of monitored credentials for employees and vendors working for an enterprise, the monitored credentials being susceptible to exposure in the event one or more of the employees or vendors associated therewith is compromised;
a breach records controller configured for receiving a plurality of breach records for a plurality of data breaches, each breach record representing breached data exposed as a result of the data breach associated therewith;
a compromised credentials controller configured for comparing the monitored credentials to the breached data to identify one or more compromised credentials, the compromised credentials representing the monitored credentials exposed as a result of the data breaches; and
a monitor controller configured for generating a dashboard to visually provide a holistic view of security and financial risks posed to the enterprise as a result of the compromised credentials, the dashboard being electronically displayable through a user interface.

27. The enterprise risk management and protection system according to claim 26, wherein:
the monitor controller is configured for generating an accumulated enterprise risk score for display within an accumulated risk callout portion of the dashboard, the accumulated enterprise risk score presenting a performance metric for holistically reporting the security and financial risks posed to the enterprise.

28. The enterprise risk management and protection system according to claim 27, wherein:
the monitor controller is configured for displaying the accumulated enterprise risk score as a numerical value color-coded and defined relative to a normalized harm scale, the numerical value being between 0 and 100 and color-coded green when the accumulated enterprise risk score is low, yellow when the accumulated enterprise risk score is medium, and red when the accumulated enterprise risk score is high.

29. The enterprise risk management and protection system according to claim 28, wherein:
the monitor controller is configured for generating a vendor summary within a vendor callout portion of the dashboard, the vendor summary indicating a quantity of vendors identified in the monitored credentials and a quantity of the vendors identified to be high risk.

30. The enterprise risk management and protection system according to claim 29, wherein:
the monitor controller is configured for generating an employee summary within an employee callout portion of the dashboard, the employee summary indicating a quantity of employees identified in the monitored credentials and a quantity of the employees identified as being high risk.

31. The enterprise risk management and protection system according to claim 30, wherein:
the monitor controller is configured for generating a plurality of security and financial impacts for display within an impacts callout portion of the dashboard, including displaying a harm priority and a harm score relative to each of the impacts.

32. The enterprise risk management and protection system according to claim 31, wherein:
the monitor controller is configured for generating the impacts to include at a data theft or tampering impact, a ransomware impact, a corporate card fraud impact, a fraudulent disbursements impact, a fraudulent business loans impact, and/or a government program fraud impact, with the harm priorities and the harm scores being displayed in a relative relationship to the impact associated therewith.

33. The enterprise risk management and protection system according to claim 32, wherein:
the monitor controller is configured for generating an impact explanation page for each of the impacts, each impact explanation page being accessible through the impacts callout and configured for describing an impact summary and one or more associated threats for the impact related therewith.

34. The enterprise risk management and protection system according to claim 26, wherein:
the monitor controller is configured for generating a breach history profile for display within a breach history callout portion of the dashboard, including listing in the breach history profile one or more of the data breaches resulting in one or more of the compromised credentials.

35. The enterprise risk management and protection system according to claim 34, wherein:
the monitor controller is configured for including breach information within the breach history profile for each of the data breaches listed therein, the breach information indicating a breached identity, an occurrence date, a quantity of affected employees, and a quantity of affected vendors.

36. The enterprise risk management and protection system according to claim 35, wherein:
the monitor controller is configured for generating a breach explanation page for each of the data breaches listed in the breach history profile, each breach explanation page being accessible through the breach history callout and configured for describing a breach summary for the data breach associated therewith.

37. The enterprise risk management and protection system according to claim 36, wherein:
each summary identifies a source, an occurrence date, a discovery date, a number of enterprise records compromised, and an identifier for each type of the enterprise records compromises.

38. The enterprise risk management and protection system according to claim 26, wherein:
the monitor controller is configured for generating a plurality of recommended actions for display within a recommended actions callout portion of the dashboard, including associating an action priority, an action status, and an action assignee with each of the recommended actions, and displaying the recommended actions relative to the action priority associated therewith.

39. The enterprise risk management and protection system according to claim 38, wherein:
the monitor controller is configured for generating a recommendation explanation page for each of the recommended actions, each recommendation explanation page being accessible through the recommended actions callout for describing an action summary and for selecting the action assignee and the action status for the recommended action associated therewith.

40. The enterprise risk management and protection system according to claim 39, wherein:
the monitor controller is configured for risk score for a plurality of subjects for display within a subjects callout of the dashboard, the subject accumulated risk scores representing accumulated risk for the data breach of the subject associated therewith.

41. The enterprise risk management and protection system according to claim 40, wherein:
the monitor controller is configured for generating the subjects callout to be sortable according to a departments category, an employees category, and an vendors category, with each subject being individually selectable to display the subject accumulated risk score, a top impact, and a top associated threat for the subject associated therewith.

42. The enterprise risk management and protection system according to claim 26, further comprising:
a threat matrix controller configured for determining a plurality of threat vectors, each threat vector representing a threat to the enterprise as a result of the compromised credentials.

43. The enterprise risk management and protection system according to claim 42, wherein:
the threat matrix defines a plurality of vector links to be used in mapping data entries of the compromised credentials relative to the threat vectors.

44. The enterprise risk management and protection system according to claim 43, further comprising:
an impacts matrix controller configured for processing the compromised credentials and the threat vectors through an impacts matrix to determine a plurality of impact vectors, each impact vectors representing an impact on the enterprise as a result of the compromised credentials and threat vectors.

45. The enterprise risk management and protection system according to claim 44, wherein:
the impacts matrix controller defines a plurality of impact links to be used in mapping the compromised credentials and the threat vectors to one or more of the impact vectors.

46. The enterprise risk management and protection system according to claim 45, further comprising:
a preventive actions controller configured for assessing the compromised credentials, the threat vectors, and the impact vectors relative to a corrective actions matrix to determine a plurality of corrective actions, each corrective action representing an enterprise action to be taken by the enterprise to mitigate the influence of the threat vector and/or the impact associated therewith.

47. The enterprise risk management and protection system according to claim 46, wherein:
the corrective actions matrix defines a plurality of action links to be used in mapping the compromised credentials, the threat vectors, and the impact vectors to one or more of the corrective actions.
